(19) United States
(12) Patent Application Publication
(10) Pub. No.: US 2026/0142693 A1
(43) Pub. Date: May 21, 2026

(54) METHOD OF DESIGNING ADAPTIVE CODEBOOK FOR AIR-TO-AIR COMMUNICATION BETWEEN URBAN AIR MOBILITIES IN URBAN AIR MOBILITY CORRIDOR, AND APPARATUS FOR THE SAME

(71) Applicant: Seoul National University R&DB Foundation, Seoul (KR)

(72) Inventors: Keunwoo Kim, Seoul (KR); Seong-Cheol Kim, Seoul (KR)

(73) Assignee: Seoul National University R&DB Foundation, Seoul (KR)

(21) Appl. No.: 19/268,080

(22) Filed: Jul. 14, 2025

(30) Foreign Application Priority Data
Nov. 18, 2024 (KR) 10-2024-0164573

(51) Int. Cl. H04B 7/04; H04B 7/0426

(52) U.S. Cl. CPC H04B 7/04026; H04B 7/043

(57) ABSTRACT

Disclosed are a method for designing a codebook for A2A communication between UAMs that takes into account the unique topology of a UAM corridor based on the spatial characteristics of the UAM corridor, and an apparatus for the same. First, based on the structure of the UAM corridor, the density of UAMs and the communication range required for inter-UAM communication, a UAM distribution function representing the distribution of UAMs located in the UAM corridor is obtained. A beam width of a beam pattern to be generated by each codeword in the codebook is set Based on the obtained UAM distribution function. Codewords optimized for the hardware of the wireless communication system installed are designed based on each ideal beam pattern that produces the set beam width.

### CROSS-REFERENCE TO RELATED APPLICATION

This U.S. non-provisional application claims priority under 35 USC § 119 to Korean Patent Application No. 10-2024-0164573, filed on Nov. 18, 2024, in the Korean Intellectual Property Office (KIPO), the disclosure of which is incorporated by reference herein in its entirety.

### BACKGROUND

### 1. Technical Field

Example embodiments relate to a technology for communication between urban air mobilities (UAMs) operating over a specific route in the air, and more particularly to a design technology for a codebook applicable to communication between UAMs operating in a UAM corridor.

### 2. Discussion of the Related Art

UAM is a general term for transportation that moves through the air in urban areas and is a subset of advanced air mobility (AAM), a concept which is developed by the aviation industry and governmental organizations such as the Federal Aviation Administration (FAA) and the National Aeronautics and Space Administration (NASA), etc. of U.S.A. UAMs often take the form of multi-copters with multiple propellers. New aircraft such as UAMs are designed to reduce traffic congestion during peak hours in and around urban areas by taking advantage of their vertical takeoff and landing (VTOL) capabilities and maximum speeds of approximately 300 km/h.

Unlike traditional transportation, UAMs operate in the air, which raises safety concerns. Furthermore, as the primary use case for UAMs is commercial air taxis, the demand for passenger services is expected to increase significantly. Therefore, developing a robust and effective data transmission scheme for UAMs is of critical interest to avoid collisions and share awareness while providing passenger services.

To reduce operational complexity and enhance cooperation among UAMs, the FAA and NASA have introduced the concept of a UAM corridor. The UAM corridor is a specific type of restricted airspace in which UAMs are permitted to fly, and within which coordinated operations of UAMs can take place. Initial commercial corridors will be designed based on an altitude of approximately 450±150 meters above ground level. It is a three-dimensional airspace path, potentially divided into multiple tracks, each with its own performance requirements. UAMs can easily share various types of data, such as inertial measurement unit data, position data, and multi-hop data, within the UAM corridor.

However, none of the existing standards, such as Long Term Evolution (LTE) and New Radio (NR), meet the requirements for UAM communication, such as communication range and survivability in the airspace. It also mentioned the need for the development of additional communication methods, such as sidelink communication. Millimeter wave (mmWave) multiple input multiple output (MIMO) communication systems are considered promising solutions for air-to-air (A2A) communication of UAM due to their desirable characteristics.

Considering the high mobility of UAM and the complexity of implementing communication systems, it is essential to utilize codebook-based signal processing for efficient A2A communication. Most existing communication systems generally use a codebook composed of codewords with the same beam width, assuming that the distribution of users is uniform. The prior art has explored codebook designs for air-to-ground (A2G) communications and A2A communications. For example, the prior art document 1 (W. Zhang, W. Zhang, and J. Wu, “UAV beam alignment for highly mobile millimeter wave communications,” IEEE Transactions on Vehicular Technology, vol. 69, no. 8, pp. 8577-8585, 2020.) discloses a codebook design and beam tracking scheme that takes into account the location distribution and mobility of ground users. The prior art document 2 (Y. Wang, X. Wen, Y. Chen, W. Jing, and Q. Pan, “Joint 3D codebook design and beam training for UAV millimeter-wave communications,” in 2019 IEEE 30th International Symposium on Personal, Indoor and Mobile Radio Communications (PIMRC Workshops). IEEE, 2019, pp. 1-6) proposes a beam training method that utilizes a three-dimensional codebook with the same beam width and shortens the beam training time. The prior art document 3 (A. Alkhateeb, O. E. Ayach, and R. W. Heath, “Channel estimation and hybrid precoding for millimeter wave cellular systems,” IEEE Journal of Selected Topics in Signal Processing, vol. 8, no. 5, pp. 831-846, 2014.) proposes a codeword selection method that uses a codebook with the same array beam width and utilizes tracking error recognition.

### SUMMARY

However, in practice, the distribution of UAMs in a UAM corridor is not uniform, so it is essential to design a codebook suitable for A2A communication operated in a UAM corridor in order to obtain better performance.

Accordingly, the present invention is to provide a method for designing a codebook for A2A communication between UAMs that takes into account the unique topology based on the spatial characteristics of the UAM corridor, and an apparatus therefor.

The problems that the present invention is intended to solve are not limited to those described above, and may be expanded in various ways without departing from the spirit and scope of the present invention.

According to example embodiments, a method of designing a codebook for A2A communication between UAMs operating within a UAM corridor is provided. The method of designing a codebook includes obtaining a UAM distribution function representing distribution of UAMs located in the UAM corridor based on a structure of the UAM corridor, a density of UAMs, and a communication range R required for communication between UAMs, by executing a codebook design program in an operational control unit of a codebook design apparatus; setting a beam width of a beam pattern to be generated by each of codewords of the codebook based on the obtained UAM distribution function using the codebook design program executed in the operational control unit; and designing codewords optimized for hardware of a wireless communication system installed in each of the UAMs based on an ideal beam pattern for generating the set beam width using the codebook design program executed in the operational control unit.

According to example embodiments, the UAM distribution function may be a joint cumulative distribution function of azimuth and elevation angles of UAMs existing in the UAM corridor.

According to example embodiments, the obtaining the UAM distribution function may include setting the structure of the UAM corridor and the density of UAMs, and the communication range R required for communication between UAMs; obtaining an average number of UAMs existing in a sphere with a radius R centered on a transmitting UAM within a UAM corridor; obtaining an average number of UAMs existing in a geometric shape with a radius R, an azimuth angle φ, and an elevation angle θ centered on the transmitting UAM as a function of the azimuth angle φ and the elevation θ, where φ∈[0, π], and θ∈[0, π]); and obtaining a cumulative distribution function (CDF) representing a probability that UAMs exist within the geometric space centered on the transmitting UAM by dividing the average number of UAMs existing in the geometric space by the average number of UAMs existing in the sphere.

According to example embodiments, the ‘setting a beam width of a beam pattern’ may include setting a relatively narrower beam width in a direction where a probability of UAM existence is high, and a relatively wider beam width in the direction where the probability of UAM existence is low, based on the CDF according to the azimuth φ and elevation angle θ centered on the transmitting UAM within the UAM corridor.

According to example embodiments, the ‘setting a beam width of a beam pattern’ may further include assigning weights to tracks of the UAM corridor, respectively, and modifying the CDF according to the azimuth angle and elevation angle based on the weights to adjust a width of a beam toward each track to be narrower or wider.

According to example embodiments, the codewords for generating the set beam widths may be designed using an orthogonal propagation method (OPM) algorithm.

According to example embodiments, the method may further include grouping designed codewords together to construct the codebook.

Meanwhile, according to example embodiments, an apparatus for designing a codebook applicable to a wireless communication system between UAMs operating in a UAM corridor is provided. The apparatus for designing a codebook includes a storage unit for storing a codebook design program, and information of a structure of the UAM corridor, a density of UAMs in the UAM corridor, and a communication range R required for communication between UAMs; and an operational control unit configured to perform obtaining a UAM distribution function representing distribution of UAMs located in the UAM corridor based on the information of a structure of the UAM corridor, a density of UAMs in the UAM corridor, and a communication range R required for communication between UAMs, setting a beam width of a beam pattern to be generated by each of codewords of the codebook based on the obtained UAM distribution function, and designing codewords optimized for hardware of a wireless communication system installed in each of the UAMs based on an ideal beam pattern for generating the set beam width by executing the codebook design program, thereby adaptively designing the codebook based on the structure of the UAM corridor and the density of UAMs.

According to example embodiments, the apparatus may further include a communication unit configured to support communication with the UAMs, wherein the operational control unit is further configured to perform grouping the designed codewords into the codebook, transmitting the codebook to the UAMs via the communication unit to enable the codebook to be applied to the UAMs.

According to example embodiments, the ‘obtaining of the UAM distribution function’ may include setting the structure of the UAM corridor and the density of UAMs, and the communication range R required for communication between UAMs; obtaining an average number of UAMs existing in a sphere with a radius R centered on a transmitting UAM within a UAM corridor; obtaining an average number of UAMs existing in a geometric shape with a radius R, an azimuth angle φ, and an elevation angle θ centered on the transmitting UAM as a function of the azimuth angle φ and the elevation θ, where φ∈[0, π], and θ∈[0, π]); and obtaining a CDF representing a probability that UAMs exist within the geometric space centered on the transmitting UAM by dividing the average number of UAMs existing in the geometric space by the average number of UAMs existing in the sphere.

According to example embodiments, the ‘setting a beam width of a beam pattern’ may include setting a relatively narrower beam width in a direction where a probability of UAM existence is high, and a relatively wider beam width in the direction where the probability of UAM existence is low, based on the CDF according to the azimuth φ and elevation angle θ centered on the transmitting UAM within the UAM corridor.

According to example embodiments, the ‘setting a beam width of a beam pattern’ may further include assigning weights to tracks of the UAM corridor, respectively, and modifying the CDF according to the azimuth angle and elevation angle based on the weights to adjust a width of a beam toward each track to be narrower or wider.

Furthermore, according to example embodiments, a computer program product for a method of designing a codebook for wireless communication between UAMs operating in a UAM corridor is provided. The computer program product includes at least one non-transitory computer-readable storage medium having computer-executable program code portions stored therein. The computer-executable program code portions includes program code instructions for: obtaining a UAM distribution function representing distribution of UAMs located in the UAM corridor based on a structure of the UAM corridor, a density of UAMs in the UAM corridor, and a communication range R required for communication between UAMs, by executing a codebook design program in an operational control unit of a codebook design apparatus; setting a beam width of a beam pattern to be generated by each of codewords of the codebook based on the obtained UAM distribution function using the codebook design program executed in the operational control unit; and designing codewords optimized for hardware of a wireless communication system installed in each of the UAMs based on an ideal beam pattern for generating the set beam width using the codebook design program executed in the operational control unit.

In this way, the present invention allows to analyze the angular distribution between UAMs and utilize it to allocate a beam width appropriate for each codeword. In addition, the present invention proposes a weight-based beam width adjustment method to more efficiently ensure communication between UAMs on a specific track. Once an appropriate beam width is determined, a codebook can be constructed using the algorithm described in the prior art document 3.

As mentioned above, the present invention is directed to an efficient codebook design methodology based on a UAM corridor structure and UAM operational density in an inter-UAM communication situation, using codebooks with thinner beam widths in directions where UAMs are more likely to be present and wider directions where are less likely to be present. When using such a codebook according to the present invention, a stronger signal can be sent to more UAMs, thereby increasing the overall data transmission amount of the system.

In addition, the directions in which UAMs are likely to exist are usually in front of and behind the transmitting UAM, and the distance between the transmitting UAM and the receiving UAM is longer in the front and rear of the transmitting UAM than in the upper, lower, left, and right directions of the transmitting UAM. Thus, the signal attenuation of the transmission signal for the receiving UAM in front and behind the transmitting UAM occurs relatively more prominently. Therefore, by transmitting a relatively stronger signal in front and behind the transmitting UAM compared to the upper, lower, left, and right directions of the transmitting UAM according to the present invention, the signal attenuation to the front and rear of the transmitting UAM can be more significantly compensated, thereby increasing the amount of data transmission. This makes the inter-UAM communication system more reliable.

Furthermore, according to the present invention, more flexible communication system operation can be enabled by designing a codebook having a thinner beam width in the direction in which the UAM exists and granting communication priority to a UAM flying on a particular track.

The present invention has the advantage that it can be flexibly linked with conventional technologies conceived under the assumption that an ideally designed codebook exists, and is therefore readily applicable to real-world environments.

### BRIEF DESCRIPTION OF THE DRAWINGS

FIG. 1 illustrates an overview of a UAM corridor to which the present invention is applied.

FIG. 2 schematically illustrates a configuration of a codebook design apparatus for A2A communication between UAMs according to an exemplary embodiment of the present invention.

FIG. 3 schematically illustrates a configuration of a hybrid beamforming unit of an A2A wireless communication system mounted on a transmitting UAM.

FIG. 4 illustrates a design algorithm for a codebook for A2A communication between UAMs according to an exemplary embodiment of the present invention.

FIG. 5 is a flowchart illustrating a procedure for obtaining a CDF for the distribution of UAMs according to an exemplary embodiment of the present invention.

FIG. 6 shows a diagram illustrating an operation trajectory of UAMs between two vertiports in a simulation.

FIG. 7 comparatively illustrates marginal CDF (MCDF) and empirical CDF (ECDF) of UAMs in a UAM corridor.

FIG. 8 illustrates an ideal beam pattern of a codebook generated by a method according to an embodiment of the present invention, a beam pattern of a codebook designed to have a uniform beam width, and a beam pattern of a discrete Fourier transform (DFT)-based codebook.

FIG. 9 illustrates spectral efficiencies derived from codeword pairs selected through beam alignment for each of the codebook generated by the method according to an embodiment of the present invention, the codebook designed to have a uniform beam width, and the discrete Fourier transform (DFT)-based codebook.

FIG. 10 illustrates exemplary outage probabilities due to falling below a threshold value for each of the codebook generated by the method according to an embodiment of the present invention, the codebook designed to have a uniform beam width, and the discrete Fourier transform (DFT)-based codebook.

### DETAILED DESCRIPTION OF THE EMBODIMENTS

Hereinafter, preferred embodiments of the present invention will be described in more detail with reference to the accompanying drawings. The same reference numerals are used for identical components in the drawings and duplicate descriptions of the same components are omitted.

With respect to the embodiments of the present invention disclosed herein, specific structural and functional descriptions are exemplified for the purpose of illustrating embodiments of the present invention only. Embodiments of the present invention may be practiced in various forms and should not be construed as limited to the embodiments described herein. That is, the present invention may be subject to various modifications and may take many forms, and certain embodiments are illustrated in the drawings and described in detail herein. However, this is not intended to limit the present invention to any particular disclosed form, and should be understood to include all modifications, equivalents, or substitutions that fall within the scope of the idea and technology of the present invention.

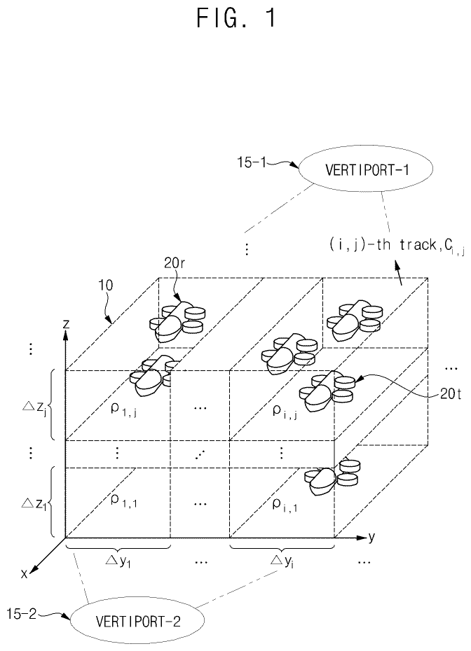

FIG. 1 illustrates an overview of a UAM corridor to which the present invention is applied.

Referring to FIG. 1, a UAM corridor 10 is an imaginary space connecting a first vertiport 15-1 and a second vertiport 15-2, which may be a square columnar structure whose cross-section is divided into a plurality of tracks in the vertical and horizontal directions, respectively. To represent the diversity of UAM corridor topologies, the UAM corridor 10 can be modeled as a set of TₕTᵥ tracks consisting of Tₕ horizontal tracks and Tᵥ vertical tracks. Each of the UAMs 20t, 20r, . . . operating between the two vertiports 15-1, 15-2 may be controlled to operate only along a designated track of the UAM corridor 10. Assuming that the UAM in the (i, j)-th track travels along the x-axis, this track is represented as an infinitely long square pillar with a width Δyᵢ, height Δzⱼ, where (i, j)∈{1, . . . , Tₕ}×{1, . . . , Tᵥ}.

C_{i,j} can be defined as the three-dimensional space where UAMs in the (i, j)-th track can exist. This can be expressed as

$${C}_{i , j} = \{ ( x , y , z ) ∈ {ℝ}^{3} \vert {y}_{i - 1} < y \leq {y}_{i} , {z}_{j - 1} < z \leq {z}_{j} \} , \qquad ( 1 )$$

where yᵢ₋₁ and yᵢ denote the left and right boundaries of C_{i,j}, while zⱼ₋₁ and zⱼ represent the lower and upper boundaries. Consequently, differences between the horizontal and vertical boundaries correspond to the width and height of C_{i,j}, i.e., yᵢ−yᵢ₋₁=Δyᵢ and zⱼ−zⱼ₋₁=Δzⱼ, where y₀=0 and z₀=0. Additionally, the number of UAMs per unit volume in C_{i,j} is defined as ρ_{i,j} and it is assumed that the UAMs within each track are uniformly distributed.

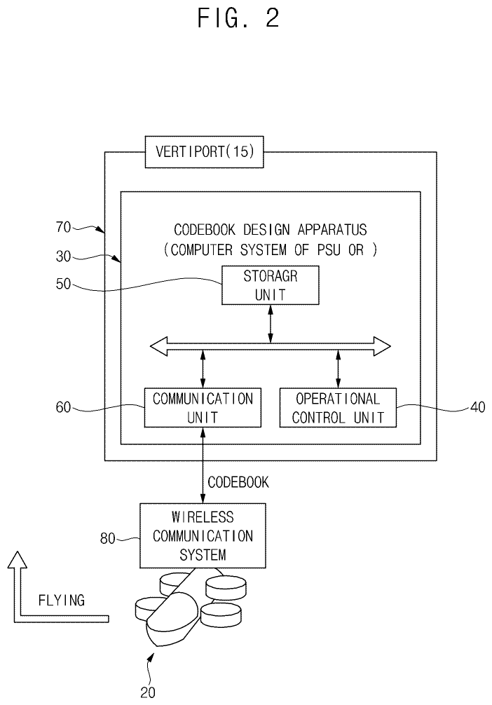

FIG. 2 schematically illustrates the configuration of a codebook design apparatus for A2A communication between UAMs, according to an exemplary embodiment of the present invention.

Referring to FIG. 2, the codebook design apparatus 30 may include an operational control unit 40, a storage unit 50, and a communication unit 60.

The communication unit 60 may a communication module configured to support communication with the UAMs. In accordance with an embodiment of the present invention, a codebook generated by the operational control unit 40 of the codebook design apparatus 30 may be delivered to each UAM 20 via the communication unit 60. The communication unit 60 may wirelessly transmit the codebook to each UAM 20, for example, in a broadcasting manner. Each UAM 20 may include an A2A wireless communication system 80 that can communicate with the communication unit 60 of the codebook design apparatus 30 to receive the codebook.

The storage unit 50 may store a computer program for designing a codebook according to an embodiment of the present invention, data concerning the structure of a UAM corridor and density of UAMs and the communication range R required for communication between UAMs, and the like. The storage unit 50 may be composed of non-volatile data storage means, such as magnetic media such as hard disks, floppy disks, and magnetic tapes, optical media such as CD-ROMs, and DVDs, magneto-optical media such as floptical disks, and ROMs, RAMs, flash memory, and the like.

The operational control unit 40 is a device capable of executing an operating system (OS) and one or more computer programs executed on the operating system, such as a codebook design program stored in the storage unit 50 and a control program capable of controlling the operation of the storage unit 50, the communication unit 60, and the like. The one or more computer programs may include a computer program for codebook design implemented based on a codebook design algorithm according to an embodiment of the present invention described later. The operational control unit 40 may be implemented using one or more general purpose computers or specific purpose computers, such as, for example, a processor, controller, arithmetic logic unit (ALU), digital signal processor, microcomputer, field programmable array (FPA), programmable logic unit (PLU), microprocessor, or any other device capable of executing and responding to instructions.

A codebook design apparatus 30 having such a configuration may be available as part of a computer system 70 for UAM control of a provider of services of UAM (PSU). The computer system 70 for UAM control may be a computer system installed in an area of the vertiport 15 and controlling, for example, the takeoff and landing of the UAM 20. In practical applications, the codebook generated in accordance with the present invention may be determined in advance by the PSU prior to departure of each UAM 20 and transmitted to each UAM 20 by broadcasting the codebook via a communication means (not shown) connected to the computer system 70 for controlling the UAM. This is possible because the PSU's computer system 70 for UAM control knows the topology of the UAM corridor 10 in advance and manages the number of UAMs per unit volume of each track in the UAM corridor 10. Then, each UAM 20 will be able to utilize this codebook during flight to establish A2A radio communication with neighboring UAMs.

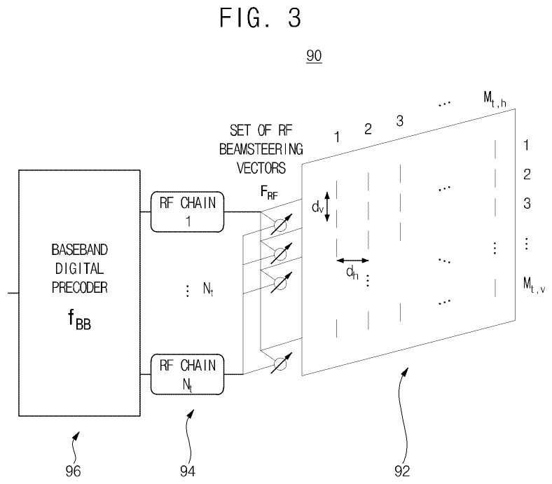

FIG. 3 schematically illustrates a configuration of a hybrid beamforming unit of an A2A wireless communication system mounted on the transmitting UAM.

Referring to FIG. 3, it may be considered that all UAMs 20 according to the exemplary embodiment are equipped with A2A communication systems operating in the millimeter wave band. The hybrid beamforming unit 90 of the A2A wireless communication system 80 of a transmitting UAM 20t may include an antenna array unit 92, a radio frequency (RF) chain unit 94, and a baseband digital precoder unit 96.

In one example embodiment, the antenna array unit 92 may include a plurality of antennas to physically transmit/receive wireless beam training signals between a transmitter and a receiver. In an exemplary embodiment, the antenna array unit 92 may be composed of a uniform planar array (UPA) with M_{t,v} vertical antennas and M_{t,h} horizontal antennas, capable of, such as, multi-input multi-output (MIMO). The UPA may be commonly provided to the transmitting UAM 20t and the receiving UAM 20r. Consequently, the UPAs of the transmission and receiving UAMs 20t, 20r may include Mₜ (Mₜ=M_{t,v}M_{t,h}) antennas and Mᵣ (Mᵣ=M_{r,w},M_{r,h}) antennas, respectively.

The Mₜ antennas of these transmitting UAMs 20t can be fully connected to Nₜ RF chains 94. The Nₜ RF chains 94 may be connected to a baseband digital precoder 96. Each RF chain may be implemented including an analog-to-digital converter (ADC) (Rx), a digital-to-analog converter (DAC) (Tx), an RF processor, a local oscillator, a mixer, and the like. The baseband digital precoder 96 may use the source signal data to generate a digital signal for beamforming. Each RF chain 94 may perform precoding using a digital signal corresponding to the intermediate frequency signal provided from the baseband digital precoder 96 to generate analog radio frequency signals to be transmitted wirelessly through each transmission antenna. The analog radio frequency signals may be subjected to appropriate phase shifting and amplification processing for each antenna and then passed to the antenna array unit 92 for transmission.

The receiving UAM 20r may have a similar configuration to the transmitting UAM 20t, i.e., the receiving UAM 20r may have a Mᵣ antenna fully connected to Nᵣ RF chains, and the Nᵣ RF chains may be connected to a baseband digital combiner. The signals received wirelessly through the Mᵣ antennas of the receiving UAM 20r may be provided to the RF chains in a phase shifted state. Each RF chain may amplify and decode the received signals. The decoded signals may be passed to the baseband combiner for combining.

The hybrid beamforming unit 90 of the A2A wireless communication system 80 may have both transmitting and receiving functions of mmWave wireless signals. If the A2A wireless communication system 80 is installed in each of the UAMs 20, each UAM 20 may be the transmitting UAM 20t that transmits mmWave wireless signals and may also be the receiving UAM 20r that receives mmWave wireless signals.

Next, a system model of the A2A wireless communication system 80 will be described. In the following description, [symbol] ³ denotes a three-dimensional field of real numbers; [symbol] denotes a field of complex numbers; [symbol] (m, C) is a complex normal distribution with mean vector m and covariance matrix C; 0ₐ is a×1 all zeros column vector; I_{M} denotes a M×M identity matrix; [symbol] [⋅] denotes an expectation value operator; |⋅| denotes a norm; and ∥⋅∥_{F} denotes a Frobenius norm. Also, A⁻¹ and A^{H} denote inverse and conjugate transpose of matrix A, respectively. Finally, A∩B denotes an intersection of A and B.

For the narrowband block fading channels, the receiving UAM 20r obtains the received signal vector y∈ [symbol] ^{M}^{ᵣ}^{×1}, which is expressed as

$$y = \sqrt{ζ} HFs + n . \qquad ( 2 )$$

Here, s denotes the transmit symbol subject to [symbol] [|s|²]=1, n· [symbol] (0_{M}_{ᵣ},I_{M}_{ₜ}) represents a vector of normalized additive white Gaussian noise, and H∈ [symbol] ^{M}^{ᵣ}^{×M}^{ₜ} represents the mmWave channel matrix,

$$ζ \dot{=} \frac{P}{{σ}^{2}} {( \frac{λ}{4 πd} )}^{η}$$

represents the average signal-to-noise ratio (SNR) per antenna, where P, σ², λ, d, and η denote the transmit power, noise power, wavelength, a distance between the transmitting UAM 20t and the receiving UAM 20r, and the path loss exponent, respectively. The beamforming vector f=F_{RF}f_{BB} used by the hybrid beamforming system may be formed by linear combining of RF beam steering vectors F_{RP}∈ [symbol] ^{M}^{ₜ}^{×N}^{ₜ} which is a set of RF beam steering vectors and the baseband digital precoder f_{BB}∈ [symbol] ^{N}^{ₜ}^{×1}.

The received signal vector y can be processed by the combining vector w and obtain the received symbol z as shown in Eq. (3).

$$z = \sqrt{ζ} {w}^{H} Hfs + {w}^{H} n . \qquad ( 3 )$$

The combining vector w, denoted as w=W_{RF}w_{BB}, is comprised of a set of RF beam steering vectors W_{RF}∈ [symbol] ^{M}^{ᵣ}^{×N}^{ᵣ} and the baseband digital combiner w_{BB}∈ [symbol] ^{N}^{ᵣ}^{×1}. The RF beam steering vectors are unit norm vectors restricted by equal gain constraints. The beamforming vector f and the combining vector w can be normalized as

$${‖ f ‖}_{2}^{2} = 1 and {‖ w ‖}_{2}^{2} = 1.$$

The UPA of the antenna array unit 92 may be mounted on the front and rear parts of the UAMs 20. Furthermore, the UPA may be comprised of antennas disposed parallel to the yz-plane. Assuming that the antennas are deployed with half-wavelength spacing in both horizontal and vertical domains, the antenna array response vector of the UPA can be defined as

$${a}_{M \text{?} , M \text{?}} ( ϕ , θ ) = {\frac{1}{\sqrt{M \text{?} , M \text{?}}} [ 1 , ⋯ , {e}^{j π ( ( {M}_{k} - 1 ) sin ϕsin θ + ( M \text{?} - 1 ) cos θ )} ]}^{T} .$$

$$\text{?} \text{indicates text missing or illegible when filed}$$

Note that Mₕ and Mᵥ represent the numbers of horizontal and vertical antennas of the UPA, and φ and θ denote the azimuth angle and elevation angle, respectively. Among the entire angular range (φ, θ)∈(−π, π]×(0, π], a smaller angular range (φ, θ)∈(−π/2, π/2]×(0, π] may be considered for practical sectorization of the UPA.

The predicted altitude of the UAM corridor would be e.g. about 0.5 km or more, which is much higher than the general ground scatterers. Since there are no significant scatterers around the UAMs, the mmWave A2A communication channel can be characterized by a single line-of-sight channel. Therefore, the mmWave channel H is described as

$$H = \sqrt{{M}_{t} M \text{?}} {e}^{j \text{?}} {a}_{M \text{?} , M \text{?}} ( {ϕ}_{r} , {θ}_{r} ) {a}_{M \text{?} , M \text{?}}^{H} ( {ϕ}_{t} , {θ}_{t} ) , \qquad ( 4 )$$

$$\text{?} \text{indicates text missing or illegible when filed}$$

where a_{M}_{_{t,h}}_{,M}_{_{t,v}}(φₜ,θₜ) and a_{M}_{_{r,h}}_{,M}_{_{r,v}}(φᵣ,θᵣ) represent the antenna array response vectors of the transmitting and receiving UAMs 20t, 20r. Also, φₜ, φᵣ and θₜ, θᵣ denote the azimuth and elevation angles of departure and arrival of the dominant radio path.

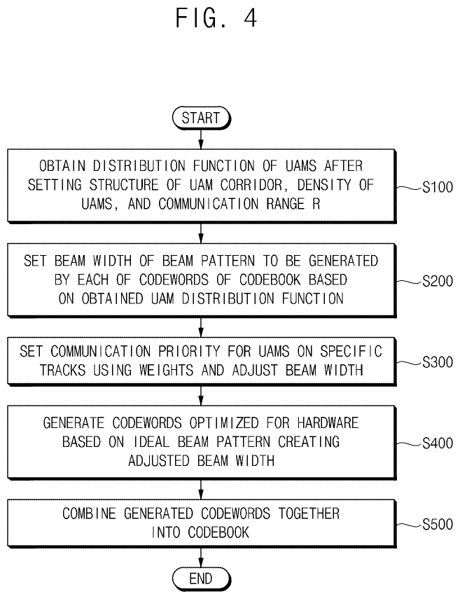

The flowchart of FIG. 4 illustrates a design algorithm for a codebook for A2A communication between UAMs according to an exemplary embodiment of the present invention.

A schematic concept of the codebook design algorithm according to an exemplary embodiment of the present invention is that in A2A wireless communication between UAMs operating in a UAM corridor having a structure in the form of a collection of multiple tracks, the codebook design algorithm utilizes prior information about the UAM corridor structure and the density of UAMs operating in each track to derive angular distributions among the UAMs within the UAM corridor, and then based on the UAM angular distributions, designs codewords to generate a beam pattern with a thinner beam width in the direction where UAM is more likely to exist, and a wider beam width in the direction where UAM is less likely to exist. At this time, if a higher communication priority is to be given to a UAM operating on a specific track, the codeword can be designed to have a thinner beam width in that direction by setting a different weight for the track.

The codebook design algorithm will be described in more detail with reference to FIG. 4. The codebook design algorithm described herein may be implemented as computer programs executable by a computer device. The computer program for the codebook design may be stored in the storage unit 50 and may be read from the storage unit 50 by the operational control unit 40 to execute.

First, as a foundation for the codebook design, the structure of the UAM corridor 10, the density of UAMs and the size of the radius R of the communication sphere may be set (step S100). Let's consider a scenario of communication between UAMs flying along the UAM corridor 10 which has a plurality of tracks in the form of square pillars, as shown in FIG. 1. The structure of the UAM corridor 10 may include topology information, including information about the length and cross-sectional size of the UAM corridor 10, the number of horizontal and vertical tracks in the corridor 10 along which the UAMs travel, the width and height of each track, and the like. The UAM density may be a density of UAMs operating on each track within the UAM corridor 10, such as an average number of UAMs per unit volume. R represents the communication range, which is the radius of the communication sphere, required for communication between UAMs. The value of R may be determined based on the desired communication performance based on the communication coverage between the UAMs, and may be set to a value at least equal to or greater than the minimum communication coverage required between one UAM and another UAM, for example. It may be assumed that the UAM corridor structure and the density of UAMs flying on a particular track are known in advance. In this case, the height and width of each track may be different, and the density of UAMs within each track may also be different. The size of the radius R of the communication sphere may be set by the user as an appropriate value. The operational control unit 40 passes these data to the codebook design program so that they can be set.

Then, the operational control unit 40 may obtain a UAM distribution function representing a distribution of UAMs present in the UAM corridor 10 based on the structure of the UAM corridor 10 and density of UAMs, the size of the radius R of the communication sphere, and the like (step S100). In one embodiment, the UAM distribution function may be a joint cumulative distribution function of the azimuths and elevation angles of the UAMs present in the UAM corridor 10.

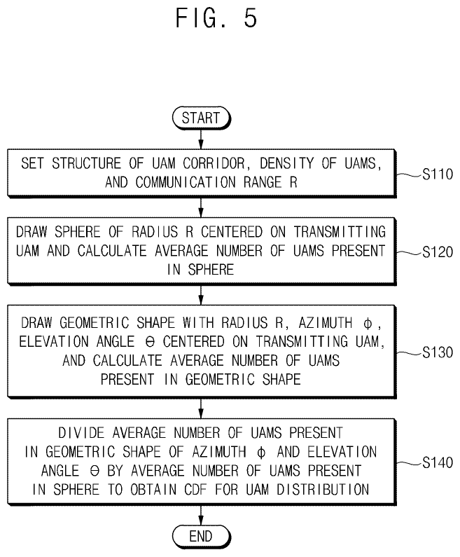

FIG. 5 further illustrates the process of deriving a function representing the distribution of UAMs in a UAM corridor (i.e., step S100 of FIG. 4), according to an exemplary embodiment.

Referring to FIG. 5, the operational control unit 40 first sets the UAM corridor structure, UAM density, and a value of R given as known values (step S110). Then, the operational control unit 40 assumes that one of the UAMs in the UAM corridor 10 is the transmitting UAM 20t. The operational control unit 40 draws a sphere of radius R centered on the transmitting UAM 20t and calculates the average number of UAMs present in the sphere (step S120). Further, the operational control unit 40 draws a geometric shape (a segment of the sphere) with an azimuth φ∈[0, 2π] and an elevation angle θ∈[0, π] in the sphere of radius R centered on the transmitting UAM 20t, i.e., the communication sphere, and calculates an average number of UAMs present in the geometric shape as a function of azimuth angle φ and elevation angle θ (step S130). Then, the operational control unit 40 divides the average number of UAMs present in the geometric shape with azimuth φ and elevation angle θ by the average number of UAMs present in the sphere. This allows the operational control 40 to obtain the CDF for the UAMs present within the UAM corridor 10 to be present within a segment space of the azimuth φ and elevation angle θ centered on the transmitting UAM 20t (step S140).

The process of obtaining the CDF for the UAM distribution will be described in more detail. First, the following A2A communication scenario may be considered: (i) The transmitting UAM 20t may be randomly selected within a three-dimensional space, [symbol] _{i,j}, where the UAM of the (i, j)-th track can exist. Here, (ĩ,\tilde{j})∈{1, . . . , Tₕ}×{1, . . . , Tᵥ}. The horizontal and vertical position of the transmitting UAM 20t may be modeled using a random variable (Y̅,Z̅). (ii) The transmitting UAM 20t seeks to establish a communication link with any UAMs located within a sphere with radius R, referred to as the communication sphere. Among the UAMs within the communication sphere, one UAM may be randomly selected as the receiving UAM 20r.

In one embodiment, the goal is to design a codebook considering the spatial characteristics of the UAM corridor 10 for a transmitting UAM 20t within the three-dimensional space [symbol] _{i,j}. Assume that random variables Φ and Θ represent the azimuth and elevation angles between the transmitting UAM 20t and the receiving UAM 20r. The statistical features of Φ and Θ around the transmitting UAM 20t depend on the position of the selected UAM. To design the beamforming codebook considering the spatial characteristics of the UAM corridor 10, it is needed to analyze the statistical features of Φ and Θ. This can be done by analyzing the joint CDF of Φ and Θ, where the transmitting UAM 20t is located within [symbol] _{i,j}, i.e.,

$${F}_{\text{?}}^{( \text{?} )} ( ϕ , θ ) .$$

$$\text{?} \text{indicates text missing or illegible when filed}$$

To derive

$${F}_{\text{?}}^{( \text{?} )} ( ϕ , θ ) ,$$

$$\text{?} \text{indicates text missing or illegible when filed}$$

the distribution of positions of the transmitting UAMs 20t within the three-dimensional space [symbol] _{i,j} is considered. Assuming that the UAMs within each track of the UAM corridor 10 are uniformly distributed, and that the horizontal and vertical positions of the UAMs in each track are independent, \tilde{Y} and \tilde{Z} are independent and follow a uniform distribution within [symbol] _{i,j}. Thus, the probability density functions (PDF) of \tilde{Y} and \tilde{Z} for the transmitting UAM (20t) within [symbol] _{i,j} may be given as given by Eq. (5).

$${f}_{\overline{Y}}^{( \text{?} )} ( \tilde{y} ) = \frac{1}{Δ y \text{?}} , for {y}_{\text{?} - 1} < \tilde{y} \leq y \text{?} \qquad ( 5 )$$

$${f}_{\overline{Z}}^{( \text{?} )} ( \tilde{z} ) = \frac{1}{Δ z \text{?}} , for {z}_{\text{?}} - 1 < \tilde{z} \leq z \text{?}$$

$$\text{?} \text{indicates text missing or illegible when filed}$$

It should be reminded that the statistical features of the azimuthal angle Φ and elevation angle Θ around the transmitting UAM (20t) depend on the horizontal and vertical positions of the selected UAM. For this reason, the partial derivative of

$${F}_{\text{?}}^{( \text{?} )} ( ϕ , θ )$$

$$\text{?} \text{indicates text missing or illegible when filed}$$

can be derived by using the conditional CDF of Φ and Θ given (\tilde{Y},\tilde{Z})=(\tilde{y},\tilde{z}) such that

$$\frac{{\partial }^{2} {F}_{\text{?}}^{( \text{?} )} ( ϕ , θ )}{\partial ϕ \partial θ} = {f}_{\text{?}}^{( \text{?} )} ( ϕ , θ ) = {\int }_{{z}_{\text{?} - 1}}^{{z}_{\text{?}}} {\int }_{{y}_{\text{?} - 1}}^{{y}_{\text{?}}} {f}_{\text{?} , \overline{Y} , \overline{Z}}^{( \text{?} )} ( ϕ , θ , \tilde{y} , \tilde{z} ) d \tilde{y} d \tilde{z} = {\int }_{{z}_{\text{?} - 1}}^{{z}_{\text{?}}} {\int }_{{y}_{\text{?} - 1}}^{{y}_{\text{?}}} {f}_{\text{?} , \overline{Y} , \overline{Z}}^{( \text{?} )} ( ϕ , θ \vert \tilde{y} , \tilde{z} ) {f}_{\overline{Y} , \overline{Z}}^{( \text{?} )} ( \tilde{y} , \tilde{z} ) d \tilde{y} d \tilde{z} {=}^{( a )} {\int }_{{z}_{\text{?} - 1}}^{{z}_{\text{?}}} {\int }_{{y}_{\text{?} - 1}}^{{y}_{\text{?}}} {f}_{\text{?} \vert \overline{Y} , \overline{Z}}^{( \text{?} )} ( ϕ , θ \vert \tilde{y} , \tilde{z} ) {f}_{\overline{Y}}^{( \text{?} )} ( \tilde{y} ) {f}_{\overline{Z}}^{( \text{?} )} ( \tilde{z} ) d \tilde{y} d \tilde{z} {=}^{( b )} {\int }_{{z}_{\text{?} - 1}}^{{z}_{\text{?}}} {\int }_{{y}_{\text{?} - 1}}^{{y}_{\text{?}}} {f}_{\text{?} \vert \overline{Y} , \overline{Z}}^{( \text{?} )} ( ϕ , θ \vert \tilde{y} , \tilde{z} ) \frac{1}{Δ y \text{?}} \frac{1}{Δ z \text{?}} d \tilde{y} d \tilde{z} = \frac{1}{Δ y \text{?}} \frac{1}{Δ z \text{?}} {\int }_{{z}_{\text{?} - 1}}^{{z}_{\text{?}}} {\int }_{{y}_{\text{?} - 1}}^{{y}_{\text{?}}} \frac{{\partial }^{2} {F}_{\text{?} \vert \overline{Y} , \overline{Z}}^{( \text{?} )} ( ϕ , θ \vert \tilde{y} , \tilde{z} )}{\partial ϕ \partial θ} d \tilde{y} d \tilde{z} , \qquad ( 6 )$$

$$\text{?} \text{indicates text missing or illegible when filed}$$

where (a) is derived from the assumption that \tilde{Y} and \tilde{Z} are independent, and (b) is derived from Eq. (5). To derive

$${F}_{Φ , Θ}^{( i , j )} ( ϕ , θ ) ,$$

it is firstly needed to deriv

$${F}_{Φ , Θ \vert \overline{Y} , \overline{Z}}^{( i , j )} ( ϕ , θ \vert \tilde{y} , \tilde{z} )$$

as shown in Eq. (6).

Now, let's consider a segment of the communication sphere. When we cut the communication sphere at azimuth Φ=0, φ and elevation angle Θ=0, θ, passing through its center, a pointed shape (a segment of the communication sphere) is formed with its apex at (\tilde{y},\tilde{z}). It is important to note that the three-dimensional space [symbol] _{R,φ,θ\tilde{y},\tilde{z}} is determined by the angles φ and θ, which are functions of (\tilde{y},\tilde{z}). The segment of the communication sphere, [symbol] _{R,φ,θ\tilde{y},\tilde{z}}, which represents the pointed shape, can be defined by

$${S}_{ℝ , ϕ \text{?}} = \{ ( x , y , z ) ∈ {ℝ}^{\text{?}} \vert 0 \leq {tan}^{- 1} ( \frac{y - \tilde{y}}{x} ) \leq ϕ , \qquad ( 7 )$$

$$0 \leq {cos}^{- 1} ( \frac{z - \tilde{z}}{\sqrt{{x}^{2} + {( y - \tilde{y} )}^{2} + {( z - \text{?} )}^{2}}} ) \leq θ ,$$

$$0 \leq \sqrt{{x}^{2} + {( y - \tilde{y} )}^{2} + {( z - \tilde{z} )}^{2}} \leq ℝ \} ,$$

$$\text{?} \text{indicates text missing or illegible when filed}$$

Assuming that R is a predetermined constant [symbol] _{φ,θ\tilde{y},\tilde{z}} will be used in place of S_{R,φ,θ\tilde{y},\tilde{z}} in the following description.

From now on,

$${F}_{Φ , Θ \vert \overline{Y} , \overline{Z}}^{( i , j )} ( ϕ , θ \vert \tilde{y} , \tilde{z} )$$

may be derived by calculating the ratio between the expected number of UAMs within the segment of the communication sphere, i.e., [symbol] _{,φ,θ\tilde{y},\tilde{z}}, and the expected number of UAMs within the entire communication sphere. Here, V_{i,j}(φ,θ|\tilde{y},\tilde{z}) is defined as the volume of the space where the three-dimensional space [symbol] _{i,j} intersects with the segment of the communication sphere [symbol] _{φ,θ\tilde{y},\tilde{z}}, which can be expressed as

$${V}_{i , j} ( ϕ , θ \vert \tilde{y} , \tilde{z} ) = Volume of {𝒞}_{i , j} ⋂ {𝒮}_{\text{?}} . \qquad ( 8 )$$

$$\text{?} \text{indicates text missing or illegible when filed}$$

Since the number of UAMs per unit volume in the three-dimensional space [symbol] _{i,j} is defined as ρ_{i,j}, the expected number of UAMs within this intersection space can be calculated as ρ_{i,j}V_{i,j}(φ,θ|\tilde{y},\tilde{z}). Therefore, the expected number of UAMs within the pointed-shaped segment of the communication sphere [symbol] _{φ,θ\tilde{y},\tilde{z}} is represented as

$${\sum }_{i = 1}^{\text{?}} {\sum }_{j = 1}^{\text{?}} {ρ}_{i , j} {V}_{i , j} ( ϕ , θ \vert {y}^{\text{?}} , {z}^{\text{?}} ) .$$

$$\text{?} \text{indicates text missing or illegible when filed}$$

With this finding,

$$F \text{?} ( ϕ , θ \vert {y}^{\text{?}} , {z}^{\text{?}} )$$

$$\text{?} \text{indicates text missing or illegible when filed}$$

can be derived as

$$F \text{?} ( ϕ , θ \vert {y}^{\text{?}} , {z}^{\text{?}} ) = \frac{{\sum }_{i = 1}^{\text{?}} {\sum }_{j = 1}^{\text{?}} {ρ}_{i , j} {V}_{i , j} ( ϕ , θ \vert {y}^{\text{?}} , {z}^{\text{?}} )}{{\sum }_{i = 1}^{\text{?}} {\sum }_{j = 1}^{\text{?}} {ρ}_{i , j} {V}_{i , j} ( \frac{π}{2} , π \vert {y}^{\text{?}} , {z}^{\text{?}} )} . \qquad ( 9 )$$

$$\text{?} \text{indicates text missing or illegible when filed}$$

Therefore,

$$F \text{?} ( ϕ , θ )$$

$$\text{?} \text{indicates text missing or illegible when filed}$$

can be derived as

$$\begin{matrix}F \text{?} ( ϕ , θ ) {=}^{\text{?}} \frac{1}{Δ {y}_{i} Δ {\text{?}}_{\text{?}}} \int \text{?} \int \text{?} F \text{?} ( ϕ , θ \vert {y}^{\text{?}} , {z}^{\text{?}} ) d {y}^{\text{?}} d {z}^{\text{?}} \\ {=}^{\text{?}} \frac{1}{Δ {y}_{i} Δ \text{?}} \int \text{?} \int \text{?} \frac{{\sum }_{i = 1}^{\text{?}} {\sum }_{j = 1}^{\text{?}} {ρ}_{i , j} {V}_{i , j} ( ϕ , θ \vert {y}^{\text{?}} , {z}^{\text{?}} )}{{\sum }_{i = 1}^{\text{?}} {\sum }_{j = 1}^{\text{?}} {ρ}_{i , j} {V}_{i , j} ( \frac{π}{2} , π \vert {y}^{\text{?}} , {z}^{\text{?}} )} d {y}^{\text{?}} d {z}^{\text{?}}\end{matrix} , \qquad ( 10 )$$

$$\text{?} \text{indicates text missing or illegible when filed}$$

where (a) is derived by integrating the both sides of Eq. (6) with respect to the azimuth angle φ and the elevation angle θ, and (b) is derived by Eq. (9).

In this exemplary way, the CDF can be obtained that describes the distribution of UAMs with respect to the azimuth angle φ and elevation angle θ. Then, referring again to FIG. 4, the operational control unit 40 may set the beam width of the beam pattern to be generated by each codeword in the codebook based on the CDF for the obtained distribution of UAMs (step S200). That is, based on the CDF according to the azimuth angle φ and the elevation angle θ, a beam pattern with a thin beam width can be set in a place where the probability of UAM existence is high, and a beam pattern with a wide beam width can be set in a place where the probability of UAM existence is low.

Setting beam width will be described in detail below. In the operational control unit 40, a codebook design including QₕQᵥ codewords can be performed utilizing

$$F \text{?} ( ϕ , θ )$$

$$\text{?} \text{indicates text missing or illegible when filed}$$

derived from Eq. (10), where Qₕ and Qᵥ denote the numbers of horizontal codewords and vertical codewords, respectively. The angular range dedicated to the (qₕ, qᵥ)-th codeword,

$$\text{?} = ( {ϕ}_{\text{?} - 1} , {ϕ}_{\text{?}} ] \times ( {θ}_{\text{?} - 1} , {θ}_{\text{?}} ] ,$$

$$\text{?} \text{indicates text missing or illegible when filed}$$

where (qₕ,qᵥ)∈{1, . . . , Qₕ}×{1, . . . , Qᵥ}, may be determined by

$$F \text{?} ( {ϕ}_{\text{?}} ) - F \text{?} ( {ϕ}_{\text{?} - 1} ) = \frac{1}{{Q}_{\text{?}}} \text{?} \qquad ( 11 )$$

$$F \text{?} ( {θ}_{\text{?}} ) - F \text{?} ( {θ}_{\text{?} - 1} ) = \frac{1}{{Q}_{\text{?}}} \text{?}$$

$$\text{?} \text{indicates text missing or illegible when filed}$$

Here,

$$F \text{?} ( ϕ ) = F \text{?} ( ϕ , π ) and F \text{?} ( θ ) = F \text{?} ( π / 2 , θ )$$

$$\text{?} \text{indicates text missing or illegible when filed}$$

denote the MCDFs of the azimuth angle Φ elevation angle Θ. Additionally, if φ₀=−π/2, φ_{Q}_{ₕ}=π/2 and θ₀=0, θ_{Q}_{ᵥ}=π, this angular domain can be converted to the spatial frequency domain,

$${\text{?}}_{\text{?}}^{\text{?}} = ( π sin {ϕ}_{\text{?} - 1} sin {θ}_{\text{?} - 1} , π cos {θ}_{\text{?} - 1} ] \times ( π sin {ϕ}_{\text{?}} sin {θ}_{\text{?}} , π cos {θ}_{\text{?}} ] .$$

$$\text{?} \text{indicates text missing or illegible when filed}$$

In an embodiment of setting the beam pattern, weights w may be assigned to each track of the UAM corridor, and the number of UAMs to exist for each track may be adjusted using the weights (w) to modify the CDF according to the azimuth angle φ and the elevation angle θ, thereby adjusting the width of the beam directed to each track to be thinner or wider (step S300). In other words, by assigning weights w to tracks in the UAM corridor 10 respectively, the beamforming gain directed to a particular track can be enhanced.

$${w}_{i , j}^{\text{?}}$$

$$\text{?} \text{indicates text missing or illegible when filed}$$

denotes the weight of [symbol] _{i,j} with respect to the transmitting UAM within the three-dimensional space [symbol] _{i,j}. Then, ρ_{i,j} in Eq. (10) can be replaced by

$${w}_{i , j}^{\text{?}} {ρ}_{i , j} ,$$

$$\text{?} \text{indicates text missing or illegible when filed}$$

where ρ_{i,j} represents the number of UAMs per unit volume of C_{i,j}, allowing a higher weight to be assigned to a particular track. This adjustment can modify

$$F \text{?} ( ϕ , θ )$$

$$\text{?} \text{indicates text missing or illegible when filed}$$

bring about modified beams width of the codewords according to Eq. (11).

In simple terms, it is possible to adjust the priority of UAMs within certain tracks by intentionally modifying the number of UAMs within those tracks when establishing

$$F \text{?} ( ϕ , θ ) .$$

$$\text{?} \text{indicates text missing or illegible when filed}$$

The codebook design scheme presented in the exemplary embodiment allocates different beam widths to ensure an equal expected number of UAMs within the angular range for each codeword, so that the codebook can be made to produce codewords that focus more power on specific tracks through appropriate multiplication of weights.

In one embodiment, one possible weighting scheme that can accommodate various communication requirements can be provided, such as Eq. (12).

$${w}_{\text{?}}^{\text{?}} = \frac{{α}^{\sqrt{{( i - \text{?} )}^{2} + {( j - \text{?} )}^{2}}}}{{\sum }_{i = 1}^{\text{?}} {\sum }_{j = 1}^{\text{?}} {α}^{\sqrt{{( i - \text{?} )}^{2} + {( j - \text{?} )}^{2}}}} \qquad ( 12 )$$

$$\text{?} \text{indicates text missing or illegible when filed}$$

Here, α>0 represents a scaling coefficient that adjusts the priority of UAMs within tracks adjacent to [symbol] _{i,j}, where the closer it is to 0, the higher the weight is given to the adjacent track.

In the operational control unit 40, a codeword optimized for the hardware of the A2A communication system installed in the UAM can be generated based on an ideal beam pattern that produces an adjusted beam width (step S400). In this step, by considering the architecture of the hybrid beamforming unit 90, in particular, the number and connectivity of the RF chains 94 and the antenna array 92, a set of codewords optimized therefor can be configured.

In one embodiment, based on a predetermined codeword design technique, the (qₕ,qᵥ)-th ideal codeword

$${f}_{\text{?}}^{ideal}$$

$$\text{?} \text{indicates text missing or illegible when filed}$$

may be designed to generate a flat beamforming gain

$${τ}_{{q}_{h} , {q}_{u}} = min \{ 1 , \frac{{( 2 π )}^{2}}{{M}_{h} {M}_{x} \text{?}} \}$$

$$\text{?} \text{indicates text missing or illegible when filed}$$

for

$$( ϕ , θ ) ∈ {v}_{\text{?}}^{AD}$$

$$\text{?} \text{indicates text missing or illegible when filed}$$

according to Parseval's theorem, and zero beamforming gain for

$$( ϕ , θ ) ∈ ( - π / 2 , π / 2 ] \times ( 0 , π ] \backslash {v}_{\text{?}}^{AD} .$$

$$\text{?} \text{indicates text missing or illegible when filed}$$

The above-described codeword design technique may be the design technique described in J. Song, J. Choi, and D. J. Love, “Codebook design for hybrid beamforming in millimeter wave systems,” in 2015 IEEE International Conference on Communications (ICC). IEEE, 2015, pp. 1298-1303). Thus, the ideal codeword

$${f}_{\text{?}}^{ideal}$$

$$\text{?} \text{indicates text missing or illegible when filed}$$

may be designed to satisfy Eq. (13).

$${\vert {( {f}_{{q}_{h} , {q}_{v}}^{ideal} )}^{H} {a}_{{M}_{k} , {M}_{v}} ( ϕ , θ ) \vert}^{2} = \{ \begin{matrix}{τ}_{\text{?}} , & ( ϕ , θ ) ∈ {v}_{\text{?}}^{AD} , \\ 0 , & ( ϕ , θ ) ∈ ( - π / 2 , π / 2 ] \times ( 0 , π ] \backslash {v}_{\text{?}}^{AD`}\end{matrix} \qquad ( 13 )$$

$$\text{?} \text{indicates text missing or illegible when filed}$$

Since the present invention is directed to design a codeword that generates a beam pattern similar to the ideal one, it may be needed to solve

$$\{ {F}_{RF , \text{?}}^{\text{?}} , {f}_{BB , \text{?}}^{\text{?}} \} = {arg min}_{{F}_{RF , \text{?}} , {f}_{BB , \text{?}}} {‖ {f}_{\text{?}}^{ideal} - {F}_{RF , \text{?}} {f}_{BB , \text{?}} ‖}_{2} \qquad ( 14 )$$

$$s . t . {‖ {F}_{RF , \text{?}} {f}_{BB , \text{?}} ‖}_{2}^{2} = 1.$$

$$\text{?} \text{indicates text missing or illegible when filed}$$

Eq. (14) represents the principle of obtaining a set of RF beam steering vectors

$${F}_{RF , \text{?}}^{opt}$$

$$\text{?} \text{indicates text missing or illegible when filed}$$

that form a beam forming vector

$${f}_{{q}_{h} , {q}_{v}}^{ideal}$$

that generates a (qₕ, qᵥ)-th ideal beam pattern according to the design principle presented in one embodiment, and a baseband digital

$${f}_{BB , {q}_{h} , {q}_{v}}^{opt} .$$

The right side of Eq. (14) shows obtaining a linear combination F_{RF,q}_{ₕ}_{,q}_{ᵥ}f_{BB,q}_{ₕ}_{,q}_{ᵥ} of RF beam steering vectors that minimizes the difference with the beam forming vector

$${f}_{{q}_{h} , {q}_{v}}^{ideal} .$$

Since there is no closed-form solution in Eq. (14), an approximated solution for Eq. (14) may be obtained based on a predetermined codeword design algorithm. In one example, a codeword that generates the set beam width can be designed using the codeword design algorithm presented in the prior art document 3. The linear combination of RF beam steering vectors that minimizes the difference with the beam forming vector can be used to design an A2A codeword using an orthogonal propagation method (OPM) algorithm. Each column of F_{RF,q}_{ₕ}_{,q}_{ᵥ} is selected from a finite set of array response vectors a_{M}_{ₕ}_{,M}_{ᵥ}(φₘ,θₙ), where

$${ϕ}_{m} = - \frac{π}{2} + \frac{x}{{N}_{p}} m and {θ}_{n} = \frac{π}{{N}_{p}} n .$$

Here, (m, n)∈{1, . . . , Nₚ}×{1, . . . , Nₚ} and Nₚ denotes the number of possible array response vectors for azimuth angle φ and elevation angle θ, respectively. Each component of F_{RF,q}_{ₕ}_{,q}_{ᵥ}, which is the matrix representing the set of RF beam steering vectors, has a magnitude of 1 and a phase value between 0 and 2π. The phase of each component of F_{RF,q}_{ₕ}_{,q}_{ᵥ} can be controlled by a B-bit phase control register, where the phase of each component has one of 2^{B} discrete values rather than a continuous value.

Finally, the operational control unit 40 may construct a codebook by combining the obtained codewords together (step S500). That is, after the approximate solutions are obtained as described above, a beamforming codebook [symbol] ={f₁, . . . , f_{Q}_{_{t,h}}_{Q}_{_{r,v}}} and a combining codebook [symbol] ={w₁, . . . , w_{Q}_{_{r,h}}_{Q}_{_{r,v}}} can be constructed by using the obtained solutions (codewords). Here, Q_{t,h},Q_{t,v} and Q_{r,h},Q_{r,v} denote the number of horizontal and vertical codewords of the transmitting UAM 20t and the receiving UAM 20r.

$$( {\hat{q}}_{t} , {\hat{q}}_{r} ) = {arg max}_{( {q}_{t} , {q}_{r} ) ∈ Q} {\vert \sqrt{Ϛ} {w}_{{q}_{r}}^{H} {Hf}_{{q}_{t}} s + {w}_{{q}_{r}}^{H} {n}_{{q}_{t} , {q}_{r}} \vert}^{2} \qquad ( 15 )$$

From the codeword pairs (f_{q}_{ₜ}, w_{q}_{ᵣ}), where (qₜ, qᵣ)∈Q={1, . . . , Q_{t,h}, Q_{t,v}}×{1, . . . , Q_{r,h}, Q_{r,v}}, the (\hat{q}ₜ,\hat{q}ᵣ)-th codeword pair may be selected, where (\hat{q}ₜ,\hat{q}ᵣ) is determined by Eq. (15).

The obtained codebook may be provided to the UAMs and utilized for A2A communication between the UAMs. For example, the codebook may be delivered to the UAMs in such a way that the provider of services of UAM (PSU) predetermines the appropriate codebooks for the UAMs and broadcasts them to the UAMs prior to the departure of each UAM from the vertiport 15. After receiving the codebook, the UAMs can perform A2A communication based on the codebooks received.

Simulations have been conducted to assess the effectiveness of a codebook designed in a manner in accordance with an exemplary embodiment of the present invention. Each UAM is equipped with a UPA with M_{t,h}=M_{r,h}=Mₕ horizontal antennas and M_{t,v}=M_{r,v}=Mᵥ vertical antennas. These antennas are fully connected with Nₜ=Nᵣ=N RF chains. The number of bits in each phase controller may be set to B=5 and the number of possible array response vectors may be set to Nₚ=2¹¹. The transmitting and receiving codebooks may be comprised of Q_{t,h}Q_{t,v} and Q_{r,h}Q_{r,v} codewords, where Q_{t,h}=Q_{r,h}=Qₕ and Q_{t,v}=Q_{r,v}=Qᵥ. Let's consider a millimeter-wave communication system operating at 28 GHz with a bandwidth of W=200 MHz. The path loss exponent η=2 may be set, considering a line-of-sight channel. A transmit power of P∈[10, 30] dBm may be used and a noise power of σ²=NoW dBm may be assumed where the noise power spectral density is N₀=−174 dBm/Hz. Under these conditions, UAMs within a communication range R=0.5 km communicate with each other.

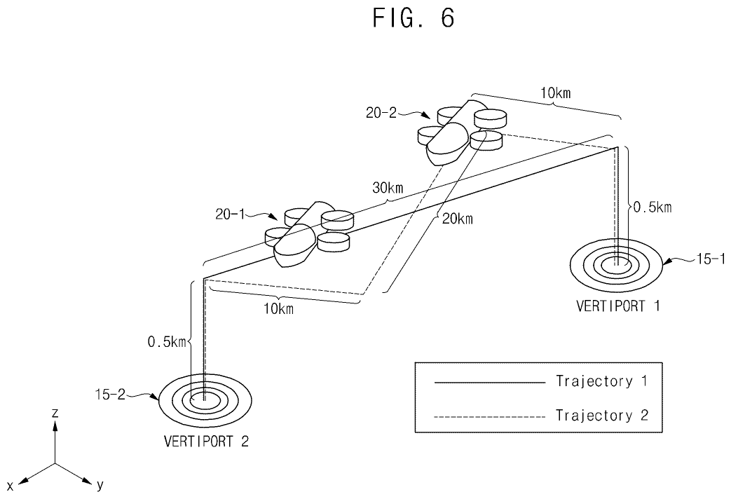

The communication performance of a codebook designed in accordance with an embodiment of the present invention is evaluated under a realistic A2A communication scenario. In this simulation, two trajectories (Trajectory 1, Trajectory 2) are considered where UAMs 20-1, 20-2 travel between two vertiports (15-1, 15-2) separated by a distance 30 km, as exemplified in FIG. 6. In the first trajectory T₁, the UAM 20-1 also takes off vertically for 0.5 km, then diagonally travels for 10 km, turns left and travels for 10 km, followed by another 10 km after turning right, and lands for 0.5 km. For both trajectories, the UAM corridor is modeled as a bundle of TₕTᵥ tracks with Tₕ2=3 horizontal tracks and Tᵥ=3 vertical tracks. The width and height of each track may be set as {Δ_{y1}, Δ_{y2}, Δ_{y3}}={0.12, 0.06, 0.12} km and {Δ_{z1}, Δ_{z2}, Δ_{z3}}={0.12, 0.06, 0.12} km. The scaling factor α=1 may be also set and the number of UAMs per unit volume may be set as

$$[ \begin{matrix}{ρ}_{1 , 1} & {ρ}_{1 , 2} & {ρ}_{1 , 3} \\ {ρ}_{2 , 1} & {ρ}_{2 , 2} & {ρ}_{2 , 3} \\ {ρ}_{3 , 1} & {ρ}_{3 , 2} & {ρ}_{3 , 3}\end{matrix} ] = [ \begin{matrix}10 & 1 & 10 \\ 1 & 0 & 1 \\ 10 & 1 & 10\end{matrix} ] ( 1 / {km}^{3} ) .$$

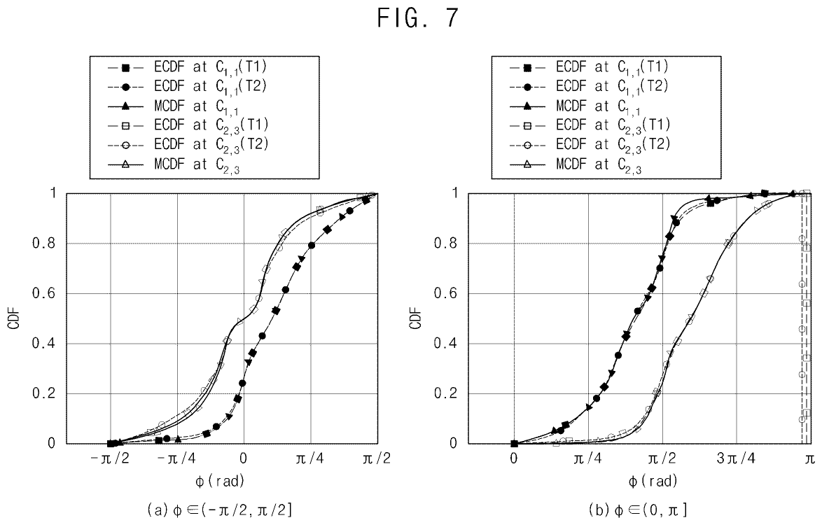

FIG. 7 shows the MCDF and ECDF derived from Eq. (10) for the angles between UAMs within the UAM corridor. The MCDF in rom Eq. (10) is compared with the ECDF, which is obtained from 10⁵ pairs of UAMs when the transmitting UAM is within C_{1,1} and C_{2,3} as shown in FIG. 7. Since there are no abrupt changes in the direction of travel in realistic A2A communication scenarios, the MCDF closely approximates the ECDF, even though the UAM corridor is not strictly modeled as an infinitely long square pillar. This explains the similarity in communication performances observed in the following simulations conducted under two different UAM trajectories.

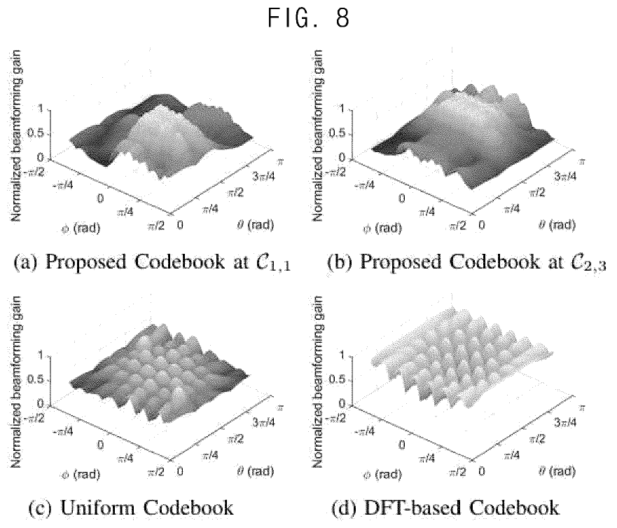

FIG. 8 illustrates examples of an ideal beam pattern of a codebook generated by a method according to one embodiment of the present invention, a beam pattern of a codebook designed to have a uniform beam width, and a beam pattern of a discrete Fourier transform (DFT)-based codebook, respectively. Note that the two-dimensional codebook is extended to three dimensional one for comparison.

The spectral efficiency

$${R}_{s} = {log}_{2} ( 1 + Ϛ {\vert {w}_{{\hat{q}}_{v}}^{H} {Hf}_{{\hat{q}}_{t}} \vert}^{2} )$$

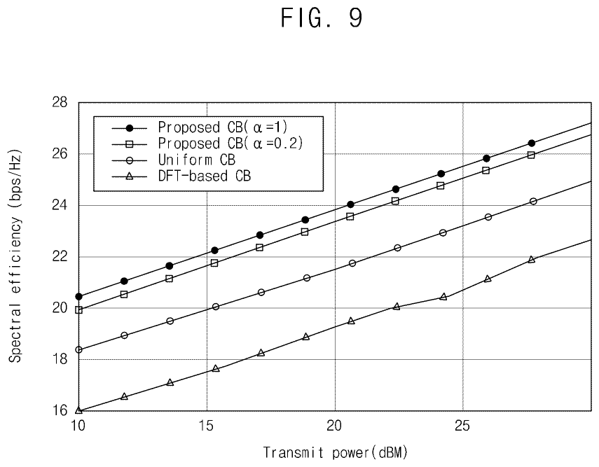

derived from the codeword pair (f_{\hat{q}}_{ₜ},w_{\hat{q}}_{ᵣ}) selected through the beam-alignment in Eq. (15) is presented in FIG. 9. As shown in FIG. 8, the simulation results confirm that the use of a codebook consisting of 64 codewords results in a higher frequency efficiency compared to the conventional codebook. That is, the codebook generated according to the present invention generates high beam forming gain in the direction where a majority of UAMs may be present, whereas the codebook generated according to other methods try to generate equal beam forming gain for entire direction. By assigning different beam widths, the codebook proposed by the present invention can concentrate more power to the direction where most of UAMs may exist. This concentration of power increases the SNR and thus improves spectral efficiency. Also, it is possible to allocate stronger beams to directions where adjacent UAMs may be located by replacing the scaling coefficient with α=0.2. This replacement puts more weight to the UAMs within nearby tracks. Since the path loss between adjacent UAMs is relatively smaller compared to UAMs at greater distances, the SNR increases, resulting in higher spectral efficiency. In other words, it can be seen that increasing the weighting for neighboring tracks (e.g., α=1→0.2) results in higher performance, this is because the UAMs located in neighboring tracks have less path loss due to their relative short distances.

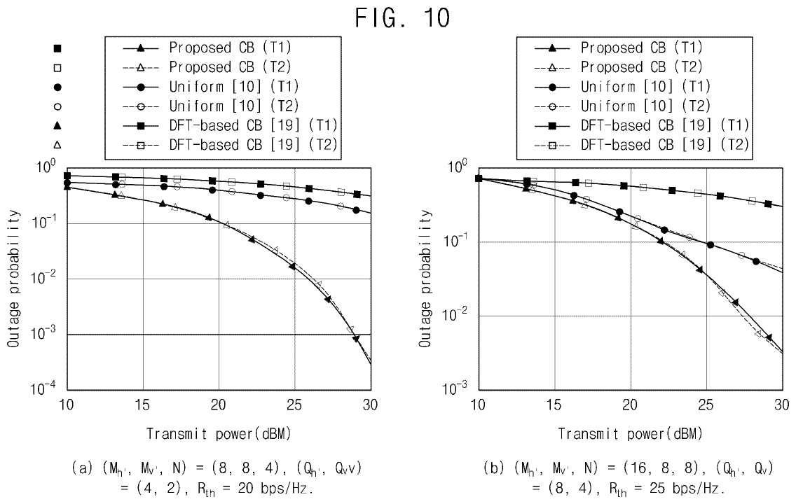

The outage probability, which represents the probability that the spectral efficiency Rs falls below the threshold Rₜₕ, is illustrated in FIG. 10. It is observed that the codebook generated according to the present invention has a lower outage probability (probability that the data rate is below a certain threshold) than the codebooks generated according to other prior arts for both T1 and T2 paths. It is believed that this is because the effect of signal attenuation according to distance was compensated by adjusting the beam width. This tendency becomes stronger as the number of codewords used decreases. When fewer codewords are used, the conventional codebooks need to broaden the beam width of each codeword to equally cover the entire directions, which reduces the beamforming gain according to Parseval's theorem. Another possible scheme is to generate high beamforming gain at the center of beam pattern and leave low beamforming gain between beam patterns of codewords. For both schemes, UAMs in weak channels are more likely to fail to communicate, leading to a higher outage probability. However, the codebook according to the present invention can effectively cover the desired direction where UAMs may exist by generating high beamforming gain at the desired direction and compensating for low beamforming gain observed between beam patterns of codewords. This enhances the robustness of the communication link and lowers the outage probability.

A codebook according to the present invention described above can be utilized in an A2A communication system between UAMs, and can achieve better data rate performance than conventional codebooks in A2A communication scenarios. Furthermore, since the present invention is a methodology for designing a codebook having different beam widths depending on the angular distribution between a transmitter and a receiver, the present invention can be applied to other communication fields in addition to the field of UAM communication.

Although the embodiments have been described with reference to limited drawings, it will be understood by those skilled in the art that various modifications and changes can be made to the present invention without departing from the spirit and scope of the present invention as set forth in the claims below. For example, suitable results can be achieved even if the described techniques are performed in a different order than the described method, and/or components of the described systems, structures, devices, circuits, etc. are combined or combined in a different form than the described method, or are replaced or substituted by other components or equivalents. Therefore, other implementations, other embodiments, and equivalents of the claims also fall within the scope of the claims set forth below.

What is claimed is:

1. A method of designing a codebook for wireless communication between UAMs operating in a UAM corridor, comprising:
obtaining a UAM distribution function representing distribution of UAMs located in the UAM corridor based on a structure of the UAM corridor, a density of UAMs in the UAM corridor, and a communication range R required for communication between UAMs, by executing a codebook design program in an operational control unit of a codebook design apparatus;
setting a beam width of a beam pattern to be generated by each of codewords of the codebook based on the obtained UAM distribution function using the codebook design program executed in the operational control unit; and
designing codewords optimized for hardware of a wireless communication system installed in each of the UAMs based on an ideal beam pattern for generating the set beam width using the codebook design program executed in the operational control unit.

2. The method of claim 1, wherein the UAM distribution function is a joint cumulative distribution function of azimuth and elevation angles of UAMs existing in the UAM corridor.

3. The method of claim 1, wherein the ‘obtaining a UAM distribution function’ comprises: setting the structure of the UAM corridor and the density of UAMs, and the communication range R required for communication between UAMs; obtaining an average number of UAMs existing in a sphere with a radius R centered on a transmitting UAM within a UAM corridor; obtaining an average number of UAMs existing in a geometric shape with a radius R, an azimuth angle φ, and an elevation angle θ centered on the transmitting UAM as a function of the azimuth angle φ and the elevation θ, where φ∈[0, π], and θ∈[0, π]); and obtaining a cumulative distribution function (CDF) representing a probability that UAMs exist within the geometric space centered on the transmitting UAM by dividing the average number of UAMs existing in the geometric space by the average number of UAMs existing in the sphere.

4. The method of claim 1, wherein the ‘setting a beam width of a beam pattern’ comprises setting a relatively narrower beam width in a direction where a probability of UAM existence is high, and a relatively wider beam width in the direction where the probability of UAM existence is low, based on a cumulative distribution function (CDF) according to the azimuth φ and elevation angle θ centered on the transmitting UAM within the UAM corridor.

5. The method of claim 4, wherein the ‘setting a beam width of a beam pattern’ further comprises assigning weights to tracks of the UAM corridor, respectively, and modifying the CDF according to the azimuth angle and elevation angle based on the weights to adjust a width of a beam toward each track to be narrower or wider.

6. The method of claim 4, wherein the codewords for generating the set beam widths are designed using an orthogonal propagation method (OPM) algorithm.

7. The method of claim 1, further comprising grouping designed codewords together to construct the codebook.

8. An apparatus for designing a codebook applicable to a wireless communication system between UAMs operating in a UAM corridor, comprising:
a storage unit for storing a codebook design program, and information of a structure of the UAM corridor, a density of UAMs in the UAM corridor, and a communication range R required for communication between UAMs; and
an operational control unit configured to perform obtaining a UAM distribution function representing distribution of UAMs located in the UAM corridor based on the information of a structure of the UAM corridor, a density of UAMs in the UAM corridor, and a communication range R required for communication between UAMs, setting a beam width of a beam pattern to be generated by each of codewords of the codebook based on the obtained UAM distribution function, and designing codewords optimized for hardware of a wireless communication system installed in each of the UAMs based on an ideal beam pattern for generating the set beam width by executing the codebook design program, thereby adaptively designing the codebook based on the structure of the UAM corridor and the density of UAMs.

9. The apparatus of claim 8, further comprising a communication unit configured to support communication with the UAMs, wherein the operational control unit is further configured to perform grouping the designed codewords into the codebook, transmitting the codebook to the UAMs via the communication unit to enable the codebook to be applied to the UAMs.

10. The apparatus of claim 8, wherein the ‘obtaining of the UAM distribution function’ comprises setting the structure of the UAM corridor and the density of UAMs, and the communication range R required for communication between UAMs; obtaining an average number of UAMs existing in a sphere with a radius R centered on a transmitting UAM within a UAM corridor; obtaining an average number of UAMs existing in a geometric shape with a radius R, an azimuth angle φ, and an elevation angle θ centered on the transmitting UAM as a function of the azimuth angle φ and the elevation θ, where φ∈[0, φ], and θ∈[0, π]); and obtaining a cumulative distribution function (CDF) representing a probability that UAMs exist within the geometric space centered on the transmitting UAM by dividing the average number of UAMs existing in the geometric space by the average number of UAMs existing in the sphere.

11. The apparatus of claim 8, wherein the ‘setting a beam width of a beam pattern’ comprises setting a relatively narrower beam width in a direction where a probability of UAM existence is high, and a relatively wider beam width in the direction where the probability of UAM existence is low, based on a cumulative distribution function (CDF) according to the azimuth φ and elevation angle θ centered on the transmitting UAM within the UAM corridor.

12. The apparatus of claim 11, wherein the ‘setting a beam width of a beam pattern’ further comprises assigning weights to tracks of the UAM corridor, respectively, and modifying the CDF according to the azimuth angle and elevation angle based on the weights to adjust a width of a beam toward each track to be narrower or wider.

13. A computer program product for a method of designing a codebook for wireless communication between UAMs operating in a UAM corridor, comprising at least one non-transitory computer-readable storage medium having computer-executable program code portions stored therein, the computer-executable program code portions comprising program code instructions for:
obtaining a UAM distribution function representing distribution of UAMs located in the UAM corridor based on a structure of the UAM corridor, a density of UAMs in the UAM corridor, and a communication range R required for communication between UAMs, by executing a codebook design program in an operational control unit of a codebook design apparatus;
setting a beam width of a beam pattern to be generated by each of codewords of the codebook based on the obtained UAM distribution function using the codebook design program executed in the operational control unit; and
designing codewords optimized for hardware of a wireless communication system installed in each of the UAMs based on an ideal beam pattern for generating the set beam width using the codebook design program executed in the operational control unit.

14. The computer program product according to claim 13, wherein the UAM distribution function is a joint cumulative distribution function of azimuth and elevation angles of UAMs existing in the UAM corridor.

15. The computer program product according to claim 13, wherein the ‘obtaining a UAM distribution function’ comprises: setting the structure of the UAM corridor and the density of UAMs, and the communication range R required for communication between UAMs; obtaining an average number of UAMs existing in a sphere with a radius R centered on a transmitting UAM within a UAM corridor; obtaining an average number of UAMs existing in a geometric shape with a radius R, an azimuth angle φ, and an elevation angle θ centered on the transmitting UAM as a function of the azimuth angle φ and the elevation θ, where θ∈[0, φ], and θ∈[0, π]); and obtaining a cumulative distribution function (CDF) representing a probability that UAMs exist within the geometric space centered on the transmitting UAM by dividing the average number of UAMs existing in the geometric space by the average number of UAMs existing in the sphere.

16. The computer program product according to claim 13, wherein the ‘setting a beam width of a beam pattern’ comprises setting a relatively narrower beam width in a direction where a probability of UAM existence is high, and a relatively wider beam width in the direction where the probability of UAM existence is low, based on a cumulative distribution function (CDF) according to the azimuth φ and elevation angle θ centered on the transmitting UAM within the UAM corridor.

17. The computer program product according to claim 16, wherein the ‘setting a beam width of a beam pattern’ further comprises assigning weights to tracks of the UAM corridor, respectively, and modifying the CDF according to the azimuth angle and elevation angle based on the weights to adjust a width of a beam toward each track to be narrower or wider.

18. The computer program product according to claim 16, wherein the codewords for generating the set beam widths are designed using an orthogonal propagation method (OPM) algorithm.

19. The computer program product according to claim 13, wherein the computer-executable program code instructions further comprise program code instructions for grouping designed codewords together to construct the codebook.
